(19) United States
(12) Patent Application Publication
(10) Pub. No.: US 2019/0329997 A1
(43) Pub. Date: Oct. 31, 2019

(54) TRAY COVER

(71) Applicant: Hewlett-Packard Development Company, L.P., Houston, TX (US)

(72) Inventors: Michael Evan Daniels, Boise, ID (US); Timothy Ric Nelson, Boise, ID (US); Eric L. Hoffman, Boise, ID (US)

(21) Appl. No.: 15/967,515

(22) Filed: Apr. 30, 2018

(51) Int. Cl. B65H 1/26; B41J 13/10

(52) U.S. Cl. CPC B65H 1/266; B41J 13/103

(57) ABSTRACT

In one example, an apparatus may include a first tray cover portion substantially parallel to a first plane, a second tray cover portion coupleable to the first tray cover portion at a first end of the first tray cover portion, and a third tray cover portion coupleable to the first tray cover portion at a second end of the first tray cover portion. The second tray cover portion and the third tray cover portion may be substantially parallel to a second plane, and the first plane and the second plane may be substantially orthogonal to one another.

### BACKGROUND

A printing device may be used to process and output a physical medium. For example, a printing device may perform a print job comprising printing text and/or graphics by transferring ink, toner, and/or other material to the physical medium.

### BRIEF DESCRIPTION OF THE DRAWINGS

FIG. 1 illustrates an example of an apparatus including a tray cover consistent with the present disclosure

FIG. 2 illustrates another example of an apparatus including a tray cover consistent with the present disclosure.

FIG. 3 illustrates an example of a system including a tray cover consistent with the disclosure.

FIG. 4 illustrates another example of a system including a tray cover consistent with the disclosure.

FIG. 5 illustrates yet another example of a system including a tray cover consistent with the disclosure.

### DETAILED DESCRIPTION

Printing devices such as toner-based printers (e.g., laser printers), liquid-based printers (e.g., inkjet printers), solid ink printers, thermal printers, etc. may provide persistent human-readable representation of graphics and/or text on print media. Print media may be paper, canvas, and/or transparency paper, among others. Print media may be offered in a variety of sizes such as letter sized (e.g., 216 mm×279 mm), A4 (e.g., 210 mm×270 mm), foolscap sized (e.g., 203 mm×330 mm), and/or legal sized (e.g., 216 mm×356 mm), etc.

In some approaches, a printing device may be provided with a capability to print graphics and/or text using one or more sizes of print media. For example, a printing device may be provided with the capability to print graphics and/or text on letter sized print media and A4 sized print media, among other combinations of print media sizes. Stated alternatively, the printing device may include a tray that may support one or more sizes of print media.

For example, some printing devices may include a tray that is designed to support letter sized print media and A4 sized print media, however, various adapters and/or extensible add-ons may allow for the tray to support additional sizes of print media (e.g., legal sized print media and/or foolscap sized print media). However, in some approaches, adapters and/or extensible add-ons may have an unsightly appearance when installed on the printing device (e.g., the adapter and/or extensible add-on may be formed of materials dissimilar to those of the printing device, thereby creating an ungainly or maladroit aesthetic), may not fully cover the extended portion of the tray when installed on the printing device, thereby allowing debris and detritus to interact with the print media prior to printing, and/or may interfere with operation of the printing device, for example, by interfering with loading and/or removing print media from the tray (e.g., in some approaches, the adapter and/or extensible add-on may be removed from the printing device when print media is loaded or removed from the tray).

Further, in some approaches, adapters and/or extensible add-ons to facilitate printing of larger sizes of print media such as legal sized print media and foolscap sized print media may comprise a one-piece construction, which may lead to increased shipping and/or packaging costs in comparison with examples of the present disclosure.

In contrast, examples herein may allow for a tray cover that aesthetically integrates with the printing device, may cover the entire extended portion of the tray when the tray is extended to facilitate support of additional sizes of print media beyond letter sized and A4 sized print media while protecting the print media from debris and detritus, and/or may allow for print media to be loaded and removed from the tray without removal of the tray cover. In some examples, the tray cover may be provided in multiple pieces (e.g., three discrete pieces), which may reduce overhead costs associated with packaging, shipping, and/or storing the tray cover. However, in examples in which the tray cover is provided in multiple pieces, the tray cover may be provided such that it is easy and/or intuitive to assemble.

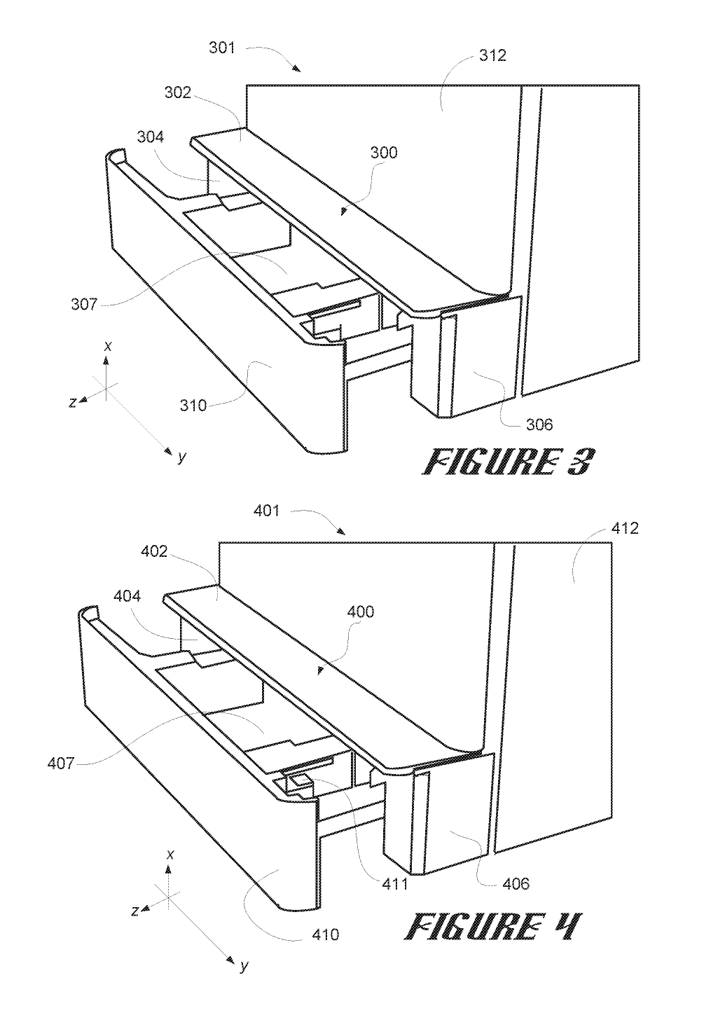

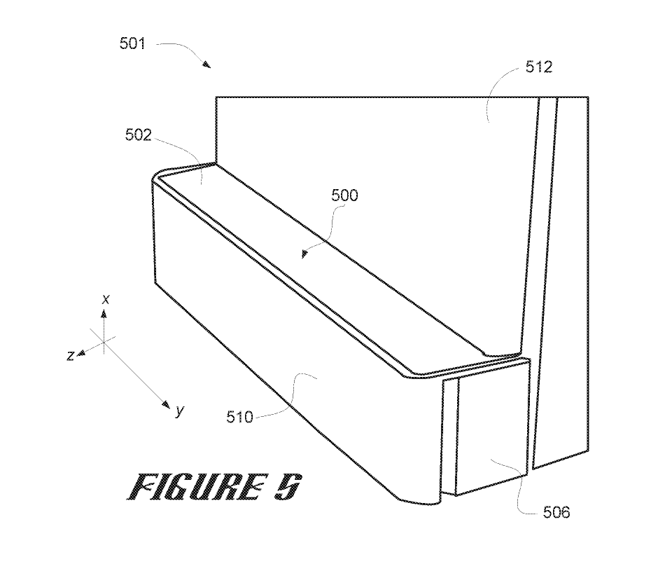

FIG. 1 is an example of an apparatus 100 including a tray cover consistent with the disclosure. The apparatus 100 may be referred to herein as a tray cover, for example, tray cover 300/400/500 illustrated and described in more detail in connection with FIGS. 3-5, herein. As shown in FIG. 1, the apparatus 100 may include a first tray cover portion 102, which may be referred to herein as an upper portion of a tray cover in connection with FIGS. 3-5, herein. The apparatus 100 may further include a second tray cover portion 104 and/or a third tray cover portion 106, which may be referred to herein as a first side portion (e.g., first side portion 304/404 illustrated in FIGS. 3-4) and a second side portion (e.g., second side portion 306/406/506 illustrated in FIGS. 3-5). The first tray cover portion 102, the second tray cover portion 104, and/or the third tray cover portion 106 may be referred to individually or in combination as an “apparatus.”

In some examples, the second tray cover portion 104 may be coupleable to the first tray cover portion 102 at a first end of the first tray cover portion 102, and/or the third tray cover portion 106 may be coupleable to the first tray cover portion 102 at a second end of the first tray cover portion 102. For example, the first tray cover portion 102 may have a first end located at a first termination of a longitudinal axis (e.g., the y-axis shown in FIG. 1) that is substantially parallel to a first plane (e.g., a plane formed by the y-axis and z-axis) formed by the first tray cover portion 102, and the first end of the first tray cover portion 102 may be coupleable to the second tray cover portion 104 at or near the first end of the first tray cover portion 102. Similarly, in some examples, the first tray cover portion 102 may have a second end located at a second termination of a longitudinal axis (e.g., a plane formed by the y-axis and z-axis) that is substantially parallel to a first plane (e.g., a plane formed by the y-axis and z-axis) formed by the first tray cover portion 102, and the second end of the first tray cover portion 102 may be coupleable to the third tray cover portion 106 at or near the second end of the first tray cover portion 102.

The second tray cover portion 104 and/or the third tray cover portion 106 may be oriented such that the second tray cover portion 104 and/or the third tray cover portion 106 are substantially parallel to a second plane (e.g., a plane formed by the x-axis and the z-axis). The first plane and the second plane may, in some examples, be substantially orthogonal to one another.

As used herein, the term “substantially” may refer to a condition that is not absolute, but is near enough to being absolute such that the condition is satisfied. For example, substantially parallel may refer to a condition that is near enough to being absolutely parallel that the condition of parallelity is satisfied. Similarly, substantially orthogonal may refer to a condition that is near enough to being absolutely orthogonal that the condition of orthogonality is satisfied. As a further non-limiting example, two objects or components may be substantially orthogonal despite not being perfectly orthogonal so long as the condition that they are relatively orthogonal to one another is satisfied in practice. Stated alternatively, due to manufacturing variances and/or manufacturing constraints, one or more objects or components may not be perfectly parallel or orthogonal to one another, however, the y may be substantially parallel or orthogonal to one another so long as they function such that the condition of orthogonality and/or the condition of parallelity is satisfied in practice.

In some examples, the first tray cover portion 102, the second tray cover portion 104, and/or the third tray cover portion 106 may be formed of a same material; however, examples are not so limited, and the first tray cover portion 102, the second tray cover portion 104, and/or the third tray cover portion 106 may be formed of different materials. For example, first tray cover portion 102 may be formed of a first material, while the second tray cover portion 104, and/or the third tray cover portion 106 may be formed of a second, different material than the first tray cover portion 102. Similarly, the second tray cover portion 104 may be formed of a different material than the third tray cover portion 106, etc.

Non-limiting examples of materials that may be used to form the first tray cover portion 102, the second tray cover portion 104, and/or the third tray cover portion 106 may include synthetic and/or semi-synthetic materials and/or polymers such as thermoplastics, thermosetting polymers, polypropylene, polyvinyl chloride, acrylonitrile butadiene styrene, polymethyl methacrylate, injection-molded synthetic and/or semi-synthetic materials, and/or carbon fiber materials, among others.

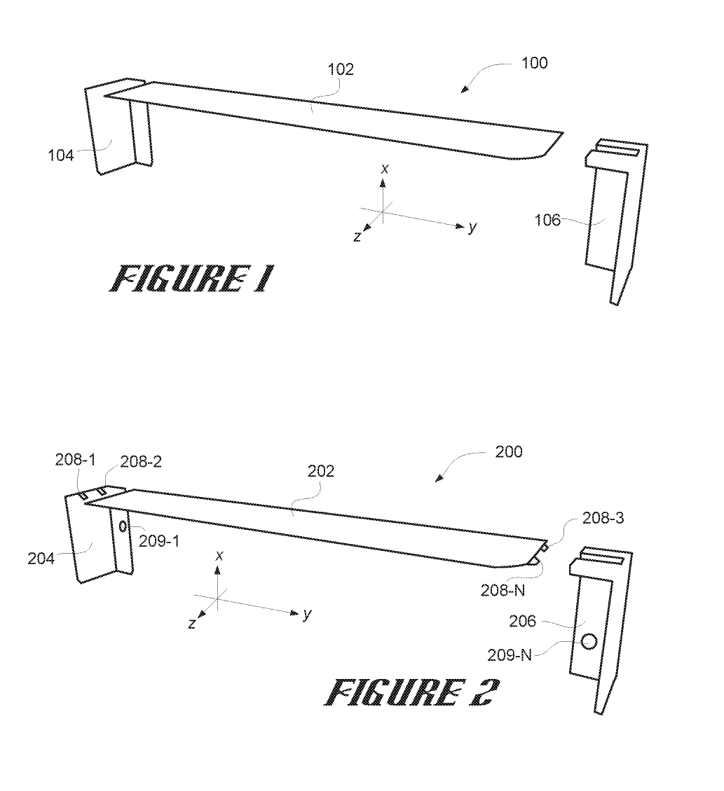

In some examples, the first tray cover portion 102, the second tray cover portion 104, and/or the third tray cover portion 106 may be separable from one another and/or connectable to one another. For example, the first tray cover portion 102, the second tray cover portion 104, and/or the third tray cover portion 106 may be provided as separate, discrete pieces, which may be connected together and/or separated from one another, as described in more detail in FIG. 2, herein. Stated alternatively, the first tray cover portion 102, the second tray cover portion 104, and/or the third tray cover portion 106 may include connecting mechanisms that may allow for the first tray cover portion 102, the second tray cover portion 104, and/or the third tray cover portion 106 to be connected together and/or separated from one another prior to or after deployment.

In some examples, the first tray cover portion 102, the second tray cover portion 104, and/or the third tray cover portion 106 may be provided (e.g., packaged and/or shipped) as discrete entities, which may allow for a reduction in container space, transport cost, and/or shipping overhead. In examples in which first tray cover portion 102, the second tray cover portion 104, and/or the third tray cover portion 106 are provided as discrete entities, a user (e.g., an end user) may be able to assemble the discrete components e,g., the first tray cover portion 102, the second tray cover portion 104, and/or the third tray cover portion 106) easily and/or efficiently, in contrast to some approaches.

FIG. 2 illustrates another example of an apparatus 200 including a tray cover consistent with the disclosure. The apparatus 200 may be referred to herein as a tray cover, for example, tray cover 300/400/500 illustrated and described in more detail in connection with FIGS. 3-5, herein. As shown in FIG. 2, the apparatus 200 may include a first tray cover portion 202, which may be referred to herein as an upper portion of a tray cover in connection with FIGS. 3-5, herein. The apparatus 200 may further include a second tray cover portion 204, a third tray cover portion 206, which may be referred to herein as a first side portion (e.g., first side portion 304/404 illustrated in FIGS. 3-4) and a second side portion (e.g., second side portion 306/406/506 illustrated in FIGS. 3-5), connecting mechanisms 208-1, . . . , 208-N, and/or alignment locations 109-1, . . . , 109-N. The first tray cover portion 202, the second tray cover portion 204, the third tray cover portion 206, the connecting mechanism 208, and/or the alignment locations 109-1, . . . , 109-N may be referred to individually or in combination as an “apparatus.” The apparatus 200 illustrated in FIG. 2 may be analogous to the apparatus 100 illustrated in FIG. 1, herein.

The connecting mechanisms 208-1, . . . , 208-N (which may be referred to herein generally as “connecting mechanism 208”) may allow for the first tray cover portion 202, the second tray cover portion 204, and/or the third tray cover portion 206 to connect to one another. For example, the first tray cover portion 202, the second tray cover portion 204, and/or the third tray cover portion 206 may be separable from one another and/or connectable to one another via the connecting mechanism 208. In some examples, the connecting mechanism 208 may enable a user to easily assemble and/or disassemble the first tray cover portion 202, the second tray cover portion 204, and/or the third tray cover portion 206 to form a tray cover such as tray cover 300/400/500 illustrated in FIGS. 3-5, herein.

As used herein, the term “connecting mechanism” may refer to a hardware device that mechanically joins or affixes two or more objects together. For example, a connecting mechanism may be used to create non-permanent joints, e.g., joints that can be removed or dismantled without damaging the joining components. Non-limiting examples of connecting mechanisms include screws, pins, clasps, clamps, buttons, interference fits, flange mechanisms, press-fit systems, tongue and groove mechanisms, snap fit mechanisms, and/or tabs, among others.

In the example apparatus 200 illustrated in FIG. 2, the connecting mechanism 208 is shown as a snap fit and/or tab connecting mechanism. Snap fit and/or tab connecting mechanisms may include a plurality of protrusions and recesses that may be pressed together to join two or more objects or components together via a mechanical coupling between a protrusion and a recess of the snap fit and/or tab connecting mechanism.

The first tray cover portion 202, the second tray cover portion 204, and/or the third tray cover portion 206 may be connectable to a printing device (e.g., printing device 312/412/512 illustrated and discussed in more detail in connection with FIGS. 3-5, herein). In some examples, the first tray cover portion 202, the second tray cover portion 204, and/or the third tray cover portion 206 may be connectable to a printing device via a tray (e.g., tray 310/410/510 illustrated and discussed in more detail in connection with FIGS. 3-5, herein) coupled to, or disposed within, the printing device.

In some examples, the first tray cover portion 202, the second tray cover portion 204, and/or the third tray cover portion 206 may be connectable to the printing device and/or the tray to cover an extendable section. An area covered by the first tray cover portion 202, the second tray cover portion 204, and/or the third tray cover portion 206 may correspond to a portion of the tray that in extendable outward from the printing device (e.g., a portion of the tray that extends along the z-axis illustrated in the Figures).

The second tray cover portion 204 and/or the third tray cover portion 206 may optionally include alignment locations 209-1, . . . , 209-N. The alignment locations 209-1, . . . , 209-N may interface with alignment guides provided on the printing device (e.g., printing device 312/412/512 illustrated and discussed in more detail in connection with FIGS. 3-5, herein) and/or may facilitate alignment of the tray cover 200 with the printing device.

FIG. 3 illustrates an example of a system 301 including a tray cover 300 consistent with the disclosure. The system 301 may include a printing device 312, a housing 307, a tray 310, and/or a tray cover 300 (which may include an upper portion 302, a first side portion 304, and/or a second side portion 306). The upper portion 302, the first side portion 304, and/or the second side portion 306 may be analogous to the first tray cover portion 102/202, the second tray cover portion 104/204, and the third tray cover portion 106/206, respectively. In some examples, the tray 310 may be disposed in the housing 307 and/or the tray 310 may be able to support print media.

As described above in connection with FIGS. 1 and 2, the upper portion 302, the first side portion 304, and/or the second side portion 306 of the tray cover 200 may be separable and/or connectable to one another via a connecting mechanism (e.g., connecting mechanism 208 illustrated in FIG. 2, herein). In some examples, the upper portion 302, the first side portion 304, and/or the second side portion 306 may be formed of a same material, may be formed of similar materials, and/or may be formed of different materials.

The tray cover 300 may be coupleable to the tray 310. Examples are not so limited, however, and the tray cover 300 may be coupleable to the printing device 312, and/or the housing 307. In some examples, the tray 310 may be allowed to extend (and retract) along a first axis of movement (e.g., along the z-axis shown in the Figures). For example, the tray 310 may be allowed to extend or retract along the first axis of movement such that the tray 310 can support different sizes of print media. In some examples, the tray 310 may be allowed to extend or retract along the first axis of movement such that the tray 310 can support a legal sized print media in addition to, or in combination with a letter sized print media and/or an A4 sized print media, among other sizes of print media.

In some examples, the tray cover 300 may be provided such that the tray 310 is allowed to extend or retract along the first axis of movement when the tray cover 300 is coupled to the printing device 312, the housing 307, and/or the tray 310. For example, the tray cover 300 may allow the tray 310 to extend out of the housing 307 along the first axis of movement of the tray 310 to a position at which the tray may support legal sized print media or print media of other sizes (e.g., foolscap sized print media).

The tray cover 300 may be coupleable to the printing device 312, the housing 307, and/or the tray 310 such that the tray 310 is accessible for loading print media when the tray cover 300 is coupled to the printing device 312. For example, in contrast to some approaches, the tray cover 300 may be provided such that print media may be loaded into, or removed from, the tray 310 while the tray cover 300 is coupled to the printing device 312, the housing 307, and/or the tray 310. This may allow for a user to easily access the tray 310 to load or remove print media when the tray cover 300 is coupled to the printing device 312, the housing 307, and/or the tray 310.

FIG. 4 illustrates another example of a system 401 including a tray cover 400 consistent with the disclosure. The system 401 may include a printing device 412, a housing 407, a tray 410, a tray cover 400 (which may include an upper portion 402, a first side portion 404, and/or a second side portion 406), and/or a lock clip 414. In some examples, the system 401 may be analogous to the system 301 illustrated in FIG. 3.

The printing device 412 may include a housing 407 that may receive the tray 410. As described above, the tray 410 may support print media. The tray 410 and/or the housing 407 may include a locking mechanism that may lock the tray 410 in a particular position during operation of the printing device 412. In some approaches, the printing device 412 may fail to operate if the locking mechanism is not engaged. In order to overcome this limitation, some examples herein include a lock clip 414 that may be coupleable to at least a portion of the tray 410, the printing device 412, and/or the housing 407. In some examples, the lock clip 414 may disable the locking mechanism disposed within the tray 410 or housing 407.

In some examples, the lock clip 414 may disable the locking mechanism such that the tray 410 may not be accidentally closed during operation of the printing device 412. For example, in some approaches, if the tray 410 is extended to support legal sized print media (or print media of other sizes), there may be a risk that the tray 410 is inadvertently closed during operation of the printing device 412. This may cause print jobs to fail and/or may cause damage to the printing device. However, as described herein, when the tray cover 400 is coupled to the printing device 412, the housing 407, and/or the tray 410, the lock clip 414 may disable the locking mechanism such that the tray 410 may not be accidentally (or purposefully) closed during operation of the printing device 412, thereby mitigating the risk of failed print jobs and/or damage to the printing device 412.

In some examples, the locking mechanism being disengaged may cause an indication that the tray 410 of the printing device 412 is open. The indication may alert a user that the tray 410 is not fully closed or may trigger a condition in the printing device 412 in which the printing device 412 does not perform print jobs. However, in some examples, the lock clip 414 may interface with the locking mechanism in such a way that the indication is suppressed, thereby allowing the printing device 412 to perform print jobs normally even when the tray 410 is extended to allow for support of print media larger than letter sized print media or A4 print media.

As described above, the tray cover 400 may include an upper portion 402, a first side portion 404, and/or a second side portion 406. The upper portion 402, the first side portion 404, and/or the second side portion 406 may be may be separable and/or connectable to one another via a connecting mechanism. Further, as described above, the upper portion 402, the first side portion 404, and/or the second side portion 406 may be formed of a same material, may be formed of similar materials, and/or may be formed of different materials.

In some examples, the upper portion 402 of the tray cover 400 may be oriented in a first plane (e.g., a plane formed by the y-axis and the z-axis), while the first side portion 404, and the second side portion 406 of the tray cover 400 may be oriented in a second plane (e.g., a plane formed by the x-axis and the z-axis). The first plane and the second plane may be substantially orthogonal to one another. For example, the second plane may be substantially orthogonal to the first plane.

In some examples, the tray cover 400 may be provided such that the tray 410 is allowed to extend (or retract) out of the housing 407 along a first axis of movement to a position at which the tray 410 supports legal sized print media (or other sizes of print media). For example, as described above, the tray cover 400 may be provided such that the tray 410 is allowed to extend (or retract) out of the housing 407 along a first axis of movement to a position at which the tray 410 supports legal sized print media (or other sizes of print media) when the tray cover 400 is coupled to the printing device 412, the housing 407, and/or the tray 410.

The first side portion 404 and/or the second side portion 406 of the tray cover 400 may include a connecting mechanism (e.g., connecting mechanism 208 illustrated in FIG. 2, herein). Similarly, in some examples, the upper portion 402 of the tray cover 400 may include a connecting mechanism. In some examples, the connecting mechanism may interface with the upper portion 402, the first side portion 404, and/or the second side portion 406. For example, the connecting mechanism may interface with the upper portion 402, the first side portion 404, and/or the second side portion 406 to couple the upper portion 402, the first side portion 404, and/or the second side portion 406 together to form the tray cover 400.

In some examples, the connecting mechanism may further allow for the upper portion 402, the first side portion 404, and/or the second side portion 406 to be decoupled from one another. Allowing for the upper portion 402, the first side portion 404, and/or the second side portion 406 to be decoupled from one another may allow for the tray cover 400 to be manufactured in separate stages, may allow for the tray cover 400 to be stored and/or transported in a smaller package or shipping container as compared to approaches in which a one-piece cover is provided.

FIG. 5 illustrates yet another example of a system 501 including a tray cover 500 consistent with the disclosure. The system 501 may include a printing device 512, a tray 510, and/or a tray cover 500, which may include an upper portion 502, and/or a second side portion 506 (the first side portion, e.g., first side portion 104/204/304/404 is not explicitly shown in FIG. 5 due to the perspective of the illustration). In some examples, the system 501 may be analogous to the system 301 illustrated in FIG. 3 and/or the system 401 illustrated in FIG. 4.

The system 501 in FIG. 5 illustrates an example in which the tray 510 is in a closed position (as opposed to the example systems 301 and 401 illustrated in FIGS. 3 and 4, where the tray 510 is in an extended position). As shown in FIG. 5, the tray 510 may be operable while the tray cover 500 is coupled to the printing device 512 and/or the tray 510. For example, the tray 510 may be retracted along the first axis of movement (e.g., the z-axis) such that it does not substantially extend outward from the printing device 512 past the tray cover 500.

The system 501 illustrated in FIG. 5 may allow for legal sized print media (or print media of other sizes) to be stored in the tray 510 for use in print jobs utilizing legal sized print media without the tray 510 (or a portion thereof) being exposed. In some examples, the system 501 illustrated in FIG. 5 may allow for print media to be loaded into, or removed from, the tray 510 while the tray cover 500 is coupled to the printing device 512 and/or the tray 510, which may allow for a user to easily access the tray 510 to load or remove print media when the tray cover 500 is coupled to the printing device 512 and/or the tray 510.

The above specification, examples and data provide a description of the method and applications, and use of the system and method of the present disclosure. Since many examples may be made without departing from the spirit and scope of the system and method of the present disclosure, this specification merely sets forth some of the many possible example configurations and implementations.

The figures follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

1. A printer media tray cover, comprising:
a substantially flat, rigid upper tray cover portion substantially parallel to a first plane that corresponds to a bottom surface of a media tray;
a first side portion coupleable to the upper tray cover portion at a first end edge of the upper tray cover portion; and
a second side portion coupleable to the upper tray cover portion at a second end edge of the upper tray cover portion, wherein the second edge is opposite the first edge across a longitudinal span of the upper tray cover portion, wherein the first side portion and the second side portion are substantially parallel to a second plane, wherein the first plane and the second plane are substantially orthogonal to one another, wherein the first and second side portions support the upper tray cover portion in an elevated position above the first plane and above print media disposed in the media tray, and wherein the first and second side portions do not contact each other when coupled to the upper tray cover portion.

2. The printer media tray cover of claim 1, wherein the upper tray cover portion, the first side portion, and the second side portion are separable from one another and connectable to one another via a connecting mechanism.

3. The printer media tray cover of claim 1, wherein the upper tray cover portion, the first side portion, and the second side portion are connectable to a printing device to entirely cover an extendable tray portion of the printing device.

4. The printer media tray cover of claim 1, wherein the upper tray cover portion, the first side portion, and the second side portion are formed of a same material.

5. A system, comprising:
a printing device including a housing;
a multiple-position tray disposed in the housing, the tray having a first position along a first axis of movement of the tray relative to the housing, and a different second position along the first axis; and
a tray cover coupleable to the printing device, wherein the tray cover comprises an upper portion, a first side portion, and a second side portion, wherein the tray cover allows the tray to extend out of the housing along the first axis in the second position, wherein the printing device is operable to print when the tray is in the first position and when the tray is in the second position, and wherein the tray is accessible by the user to load print media into the tray when the tray cover is coupled to the printing device.

6. (canceled)

7. The system of claim 5, wherein the upper portion, the first side portion, and the second side portion of the tray cover are separable from one another and connectable to one another via a connecting mechanism.

8. The system of claim 5, wherein the upper portion of the tray cover is formed of a different material than the first side portion and the second side portion of the tray cover.

9-11. (canceled)

12. The system of claim 5, wherein:
the upper portion of the tray cover is oriented in a first plane above and orthogonal to a bottom surface of the tray; and
the first side portion and the second side portion of the tray cover are oriented in a second plane orthogonal to the first plane.

13. (canceled)

14. The system of claim 5, wherein:
the first side portion and the second side portion of the tray cover include a connecting mechanism; and
the upper portion of the tray cover includes a connecting mechanism to interface with the connecting mechanism of the first side portion or the second side portion of the tray cover.

15. The system of claim 1-05, wherein the upper portion, the first side portion, and the second side portion of the tray cover are separable from one another and connectable to one another.

16. The printer media tray cover of claim 1, wherein the first end is a first edge of the upper tray cover portion and the second end is a second edge of the upper tray cover portion, the second edge along an opposing side of the upper tray cover portion from the first edge.

17. The printer media tray cover of claim 1, wherein the first and second side portions support the upper tray cover portion in a stable position above the first plane.

18. The printer media tray cover of claim 1, wherein the upper tray portion is supported above the first plane only by the first and second side portions.

19. The system of claim 5, wherein the first position corresponds to a first size of print media, and wherein the second position corresponds to a second, larger size of print media.

20. The system of claim 5, wherein the tray cover covers an entire portion of the tray that extends out of the housing when the tray is in the second position.

21. (canceled)

22. The printer media tray cover of claim 1, wherein the tray is accessible by a user to load print media into the tray when the tray and the tray cover are coupled to a printing device.

23. The system of claim 5, wherein the tray cover is coupleable to the printing device such that the tray is accessible by the user to remove print media from the tray when the tray cover is coupled to the printing device.
